(19) United States
(12) Patent Application Publication
(10) Pub. No.: US 2009/0277449 A1
(43) Pub. Date: Nov. 12, 2009

(54) RESPIRATORY GAS SUPPLY CIRCUIT TO FEED CREW MEMBERS AND PASSENGERS OF AN AIRCRAFT WITH OXYGEN

(76) Inventors: Nicolas NMI Bloch, Fontenay-Aux-Roses (FR); Severine NMI Aubonnet, Viroflay (FR)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/373,346

(22) PCT Filed: Jul. 12, 2006
(86) PCT No.: PCT/IB06/03369

§ 371 Date: Mar. 27, 2009

(51) Int. Cl. A62B 7/14

(52) U.S. Cl. 128/204.22

(57) ABSTRACT

The invention relates to a respiratory gas supply circuit (1) for an aircraft carrying passengers and crewmembers (30), comprising a source of breathable gas (R1, R2), at least one supply line (2) connected to said pressurized source, a regulating device (12) provided on said supply line for controlling the supply of breathable gas, a mixing device (9) provided on said supply line, said mixing device further comprising an ambient air inlet (10) for mixing said ambient air with said breathable gas to provide to at least one passenger or crewmember a respiratory gas corresponding to a mixture of said breathable gas and ambient air, wherein said regulating device is driven by a control signal (F_{I}O₂^{R}) function at least of the breathable gas content (F_{I}O₂) in said respiratory gas.

The present invention relates to a respiratory gas supply circuit for protecting the passengers and crewmembers of an aircraft against the risks associated with depressurization at high altitude and/or the occurrence of smoke in the cockpit.

To ensure the safety of the passengers and crewmembers in case of a depressurization accident or the occurrence of smoke in the aircraft, aviation regulations require on board all airliners a safety oxygen supply circuit able to supply each passenger and crewmember (also called hereafter end users) with an oxygen flowrate function of the cabin altitude. After a depressurization accident, the cabin altitude reaches a value close to the aircraft altitude. By cabin altitude, one may understand the altitude corresponding to the pressurized atmosphere maintained within the cabin. In a pressurized cabin, this value is different from the aircraft altitude which is its actual physical altitude.

The minimal oxygen flowrate required at a given cabin altitude generally depends on the nature of the aircraft, i.e. civil or military, the duration and the level of the protection, i.e. emergency descent, ejection, continuation of flying, . . .

A known supply circuit for an aircraft carrying passengers and/or crew members generally comprises:

a source of breathable gas, e.g. oxygen,

at least one supply line connected to the source of breathable gas,

a regulating device connected to the supply line for controlling the supply of breathable gas,

a mixing device provided on the supply line comprising an ambient air inlet for mixing the ambient air with the breathable gas to provide to passengers and/or crewmembers a respiratory gas corresponding to a mixture of breathable gas and ambient air.

The source of breathable gas may be pressurized oxygen cylinders, chemical generators, or On-Board Oxygen Generator System (OBOGS) or more generally any sources of oxygen. The respiratory gas is generally delivered to the passenger or crewmember through a respiratory device that may be a respiratory mask, a cannula or else.

The need to save oxygen on board an aircraft has lead to the development of respiratory masks comprising a demand regulator as well as oxygen dilution with ambient air (through the mixing device). Such demand regulators are known from the documents FR 2,781,381 or FR 2,827,179 disclosing a pneumatic demand regulator, or from WO2006/005372 disclosing an electro-pneumatic demand regulator. If the inhaled flowrate by an end user is generally controlled in such regulators through a feedback loop, the oxygen need is controlled with an open loop, leading to conservative and therefore excessive volume of oxygen fed to the breathing apparatus. Indeed, in such an electropneumatic regulator, the level of oxygen fed into the mask is defined upon the cabin altitude. Several costly sensors are used to measure the total flowrate and the amount of oxygen injected.

Today, there is still a need for further oxygen savings as, whether the oxygen comes from a generator or a pressurized source, the onboard oxygen mass is directly linked to the estimated need from passengers and crewmembers, also called hereafter end users. Any optimization of the oxygen supply with their actual needs will result in lighter oxygen sources, and reduced constraints on the aircraft structures and fuel consumption.

Therefore, it would be highly desirable to develop a respiratory gas supply circuit that allows to reduce the breathable gas volume carried onboard, or to extend the period before refilling the cylinders (for carried on board O₂). It would be furthermore beneficial to develop such a circuit that provides a breathable gas flowrate adjusted to the actual need of the passenger or crewmember.

To this end, there is provided a respiratory gas supply circuit for an aircraft carrying passengers and crewmembers as claimed in claim 1, and a method of delivering a respiratory gas to passengers and/or crewmembers of an aircraft according to claim 8.

With a regulation on the actual breathable gas content of the respiratory gas, the breathable gas consumption can match the actual need of an end user. No excessive volume of oxygen is fed, which reduces the need in onboard oxygen sources. This improved regulation allows a control of the supply in breathable gas based on the actual breathable gas content supplied to the end user.

The above features, and others, will be better understood on reading the following description of particular embodiments, given as non-limiting examples. The description refers to the accompanying drawing.

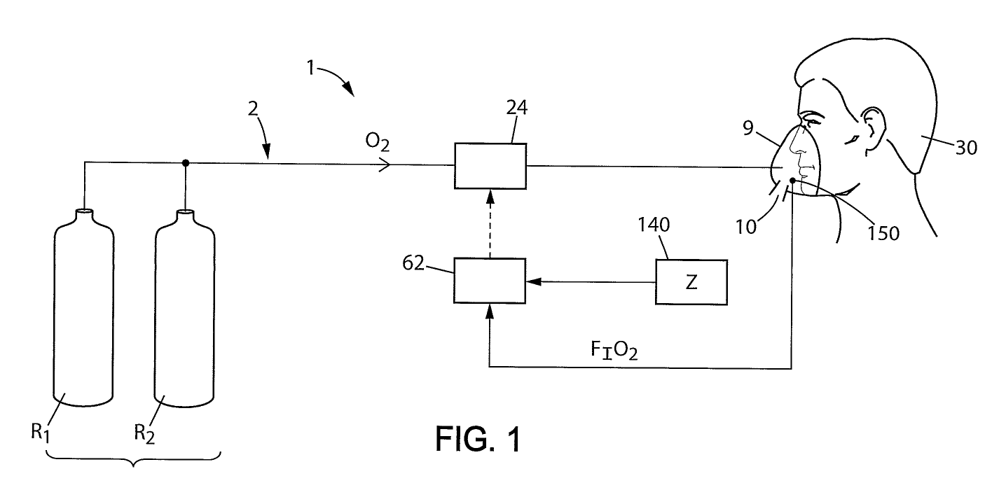

FIG. 1 is a simplified view of a respiratory gas supply circuit for an aircraft carrying passengers and crewmembers in a first embodiment of the invention;

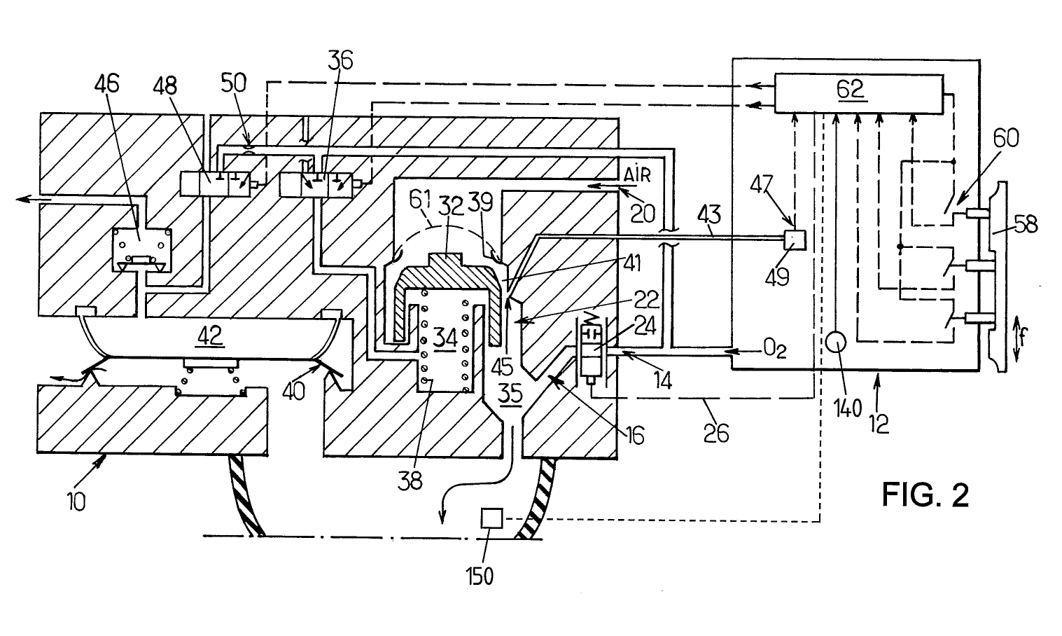

FIG. 2 illustrates an exemplary embodiment of an oxygen emergency system of a plane adapted to deliver a respiratory gas in a first embodiment of the invention.

As seen on FIG. 1, the supply circuit according to the invention comprises the hereafter elements. A source of breathable gas, here illustrated as a couple of oxygen tanks R1 and R2 each comprising a reducing valve on their respective outlet, is provided to deliver through a supply line 2 the breathable gas to the passengers and crewmembers of the aircraft. Other sources of breathable gas may be used in the supply circuit according to the invention. Supply line extends to a respiratory device, here illustrated as a respiratory mask 9. An ambient air inlet 10 is provided on the respiratory mask 9, so that ambient air is mixed with the breathable gas within said mask 9 in a mixing device (not shown in FIG. 1). Such mixing device provides a respiratory gas to be inhaled by the end user and corresponding to the mixture of the breathable gas and ambient air. In the exemplary illustration of FIG. 1, the respiratory gas to be inhaled, or in short inhaled gas, is fed to the crewmember or passenger 30 through the mask 9.

A regulating device 24 is further provided to control the supply in breathable gas to the mask 9. In the supply circuit according to the first implementation of the invention, the regulating device 24 is driven by a control signal F_{I}O₂^{R} function at least of the breathable gas content (generally named F_{I}O₂) in the respiratory gas fed to the mask 9. The regulating device may be for example an electro-valve.

To that effect an electronic unit 62, or CPU, is provided to elaborate the control signal sent to regulating device 24, as seen in doted lines in FIG. 1.

In a preferred embodiment of the circuit according to the invention, the electronic unit 62 defines a set point F_{I}O₂^{SP} for the breathable gas content F_{I}O₂ at least based on the cabin pressure (or cabin altitude, as the cabin pressure is equivalent to the cabin altitude) to control the regulating device 24. A first sensor 140, i.e. a pressure sensor, is provided in the cabin of the aircraft to supply a first pressure signal to the CPU 62 for elaborating the set point F_{I}O₂^{SP} to control the regulating device 24. Another type of sensor, measuring the cabin altitude may also be used.

Pressure sensor 140 measures the cabin pressure (measured in hPa for example), data which is equivalent to the cabin altitude (generally measured in feet) as defined before. The set point F_{I}O₂^{SP} is elaborated by the electronic unit 62 based on the regulatory curves defined by the Federal Aviation Regulation (FAR). Such curves define the required oxygen content of the respiratory gas fed to the passengers and crewmembers as a function of the cabin altitude.

The pressure sensor 140 may be one of the pressure sensors available in the aircraft, its value being available upon connection to the aircraft bus. In order to ensure a reliable reading of the pressure independent of the aircraft bus system, the circuit according to the invention may be provided with its own pressure sensor, i.e. a dedicated sensor 140 is provided for electronic unit 62.

A second sensor 150 is provided on the supply line downstream the mixing device, i.e. in the example of FIG. 1 within the mask 9, to supply the electronic circuit with a signal F_{I}O₂^{M} representative of the breathable gas content F_{I}O₂ in the inhaled gas. Second sensor 150 allows a feedback loop to ensure that the right supply in oxygen follows the actual need from the supply circuit end users when wearing the masks.

In order to generate the control signal, the electronic unit 62 compares the set point F_{I}O₂^{SP} to the signal F_{I}O₂^{M} representative of the breathable gas content to elaborate the control signal.

A PID module (proportional, integral, derivative) may be comprised within electronic unit 62 to elaborate the control signal F_{I}O₂^{R} from the comparison of the set point and the measured F_{I}O₂^{M}.

Second sensor 150 is an oxygen sensor probe adapted to measure the breathable gas content in the respiratory gas provided downstream the mixing device. Sensor 150 may be for example a galvanic oxygen sensor or an oxygen cell. As an average inspiratory phase lasts about 1 second, it is preferable that the response signal from the sensor is not significantly delayed. Therefore, in a preferred embodiment, a fast sensor is used, with response time of 5 Hz, or more, and preferably 10 Hz or higher. Thus the response signal is delayed by no more than 100 ms.

In the present illustration, the regulating device 24 drives the breathable gas supply to one mask 9. The man skilled in the art will easily transpose the teachings of the present invention to a regulation device regulating the supply in breathable gas to a cluster of masks 9 thanks to a control signal corresponding to the average F_{I}O₂ measured through each sensor 150 provided in each mask 9.

FIG. 2 illustrates an exemplary embodiment of the system according to the invention, and more specifically a demand regulator comprising a regulating device, as known from WO2006/005372.

The regulator comprises two portions, one portion 10 incorporated in a housing carried by a mask (not shown) and the other portion 12 carried by a storage box for storing the mask. The box may be conventional in general structure, being closed by doors and having the mask projecting therefrom. Opening the doors by extracting the mask causes an oxygen supply valve to open.

The portion 10 carried by the mask is constituted by a housing comprising a plurality of assembled together parts having recesses and passages formed therein for defining a plurality of flow paths.

A first flow path connects an inlet 14 for oxygen to an outlet 16 leading to the mask. A second path, or air flow path, connects an inlet 20 for dilution air to an outlet 22 leading to the mask. The flowrate of oxygen along the first path is controlled by a regulating device 24, here an electrically-controlled valve. In the example of FIG. 2, this valve is a proportional valve 24 under voltage control connecting the inlet 14 to the outlet 16 and powered by a conductor 26. It would also be possible to use an on/off type solenoid valve, controlled using pulse width modulation at a variable duty ratio.

In the example shown, the right section of the dilution air flow path is defined by an internal surface 33 of the housing, and the end edge of a piston 32 slidingly mounted in the housing. The piston is subjected to the pressure difference between atmospheric pressure and the pressure that exists inside a chamber 34. An additional electrically-controlled valve 36 (specifically a solenoid valve) serves to connect the chamber 34 either to the atmosphere or else to the source of oxygen at a higher pressure level than the atmosphere. The electrically-controlled valve 36 thus serves to switch from normal mode with dilution to a mode in which pure oxygen is supplied (so-called “100%” mode). When the chamber 34 is connected to the atmosphere, a spring 38 holds the piston 32 on seat 39 but allows the piston 32 to separate from the seat 39, when the mask wearer inhales a respiratory gas intake, so that air passes through the air flow path to the mixing device, here mixing chamber 35, where air is mixed with the incoming oxygen from the first flow path. When chamber 34 is connected to the oxygen supply, piston 32 presses against the seat 39, and thereby prevents air from passing through. Piston 32 can also be used as the moving member of a servo-controlled regulator valve. In general, regulators are designed to make it possible not only to perform normal operation with dilution, but also emergency positions thanks to selector 58.

A pressure sensor 49 is provided in the mask to detect the breath-in/breath-out cycles. In the exemplary illustration of FIG. 2, sensor 49 is provided upstream mixing chamber 35. Pressure sensor 49 is connected to the electronic circuit card 62.

Portion 10 housing also defines a breathe-out path including a exhalation or breathe-out valve 40. The shutter element of the valve 40 shown is of a type that is in widespread use at present for performing the two functions of acting both as a valve for piloting admission and as an exhaust valve. In the embodiment shown, it acts solely as a breathe-out valve while making it possible for the inside of the mask to be maintained at a pressure that is higher than the pressure of the surrounding atmosphere by increasing the pressure that exists in a chamber 42 defined by the valve 40 to a pressure higher than ambient pressure.

In a first state, an electrically-controlled valve 48 (specifically a solenoid valve) connects the chamber 42 to the atmosphere, in which case breathing occurs as soon as the pressure in the mask exceeds ambient pressure. In a second state, the valve 48 connects the chamber 42 to the oxygen feed via a flowrate-limiting constriction 50. Under such circumstances, the pressure inside the chamber 42 takes up a value which is determined by relief valve 46 having a rate closure spring.

Portion 10 housing may further carry means enabling a pneumatic harness of the mask to be inflated and deflated. These means are of conventional structure and consequently they are not shown nor described.

As illustrated in FIG. 2, a selector 58 may be provided to close a normal mode switch 60. Selector 58 allows to select the different operating modes: normal mode with dilution, 100% O2 mode or emergency mode (O2 with over pressure).

Electronic unit 62 operates as a function of the selected operating mode taking into account the signal F_{I}O₂^{M} representative of the breathable gas content in the respiratory gas, and provided by sensor 150 located downstream mixing chamber 35. Electronic unit 62 further takes into account the cabin altitude (as indicated by a sensor 140, in the example of FIG. 2 provided within the storage box 12) and the breathing cycle (as indicated by sensor 49), as no oxygen is needed when the end user breathes out.

The electronic circuit card 62 provides appropriate electrical signals, i.e. the control signal, to the first electrically-controlled valve 24 as follows. In normal mode, pressure sensor 49 indicates when the end user is breathing in (see continuous line in FIG. 2). The electronic circuit 62 receives this signal together with the cabin altitude information from sensor 140.

The electronic circuit 62 then determines the F_{I}O₂ set point F_{I}O₂^{SP} based for example on the FAR. As mentioned earlier, the electronic circuit 62 then compares the set point to the actual F_{I}O₂^{M} measured by oxygen sensor 150 downstream mixing chamber 35 and generates a control signal F_{I}O₂^{R} to drive the electrically-controlled valve 24. If more oxygen is needed, valve 24 is piloted to let more oxygen flow into mixing chamber 35. Electronic circuit 62 thus allows to drive for example the opening and closing of the electrically controlled valve 24 as well as its opening/closing speed.

1. A respiratory gas supply circuit for an aircraft carrying passengers and/or crewmembers, comprising:
a source of breathable gas,
at least one supply line connected to said source,
a regulating device provided on said supply line for controlling the supply of breathable gas,
a mixing device connected to said supply line, said mixing device further comprising an ambient air inlet for mixing said ambient air with said breathable gas to provide to at least one passenger or crewmember a respiratory gas to be inhaled corresponding to a mixture of said breathable gas and ambient air,
wherein said regulating device is driven by a control signal (F_{I}O₂^{R}) function at least of the breathable gas content (F_{I}O₂) in said respiratory gas, and the regulating device and the mixing device are comprised in a demand regulator of a respiratory mask.

2. A circuit according to claim 1, wherein the control signal is provided by an electronic circuit.

3. A circuit according to claim 2, wherein the aircraft comprises a cabin, and wherein the electronic circuit defines a set point (F_{I}O₂^{SP}) for the breathable gas content at least based on the cabin pressure to control the regulating device.

4. A circuit according to claim 2, wherein a sensor is provided downstream the mixing device to supply the electronic circuit with a signal (F_{I}O₂^{M}) representative of the breathable gas content in the respiratory gas.

5. A circuit according to claim 3, wherein a sensor is provided downstream the mixing device to supply the electronic circuit with a signal (F_{I}O₂^{M}) representative of the breathable gas content in the respiratory gas and the electronic circuit compares the set point to the signal representative of the breathable gas content to elaborate the control signal.

6. A circuit according to claim 4, wherein the sensor is a fast sensor with a response time of 50 Hz or higher.

7. (canceled)

8. A method to supply a respiratory gas in an aircraft to passengers and/or crewmembers, said aircraft comprising:
a source of breathable gas,
at least one supply line connected to said source,
a regulating device provided on said supply line for controlling the supply of breathable gas,
a mixing device connected to said supply line, said mixing device further comprising an ambient air inlet for mixing said ambient air with said breathable gas to provide to at least one passenger or crewmember a respiratory gas to be inhaled, corresponding to a mixture of said breathable gas and ambient air, and the regulating device and the mixing device are comprised in a demand regulator of a respiratory mask.
said method comprising the steps of:
measuring the breathable gas content (F_{I}O₂) in said respiratory gas,
providing a control signal to drive said regulating device, said control signal being at least based of said breathable gas content.

9. A method according to claim 8, wherein the control signal is provided by an electronic circuit.

10. A method according to claim 9, wherein the aircraft comprises a cabin, said method further comprising the steps of:
measuring said cabin pressure,
defining a set point (F_{I}O₂^{SP}) for the breathable gas content at least based on said measured cabin pressure,
driving said regulating device with said set point for the breathable gas content.

11. A method according to claim 10, wherein an oxygen sensor is provided downstream the mixing device, said method further comprising the step of
measuring with said oxygen sensor a signal (F_{I}O₂^{M}) representative of the breathable gas content in the respiratory gas.

12. A method according to claim 10, wherein an oxygen sensor is provided downstream the mixing device, said method further comprising the step of measuring with said oxygen sensor a signal (F_{I}O₂^{M}) representative of the breathable gas content in the respiratory gas and the step of comparing the set point to the signal representative of the breathable gas content to elaborate the control signal.

13. A method according to claim 11, wherein the oxygen sensor is a fast sensor with a response time of 50 Hz or higher.

14. (canceled)
